(19) United States
(12) Patent Application Publication
(10) Pub. No.: US 2006/0130627 A1
(43) Pub. Date: Jun. 22, 2006

(54) Cutting tool for soft material

(75) Inventors: Ryuichi Matsuki, Ibaraki-ken (JP); Yoshitada Ataka, Ibaraki-ken (JP); Hideo Oshima, Ibaraki-ken (JP)

Correspondence Address: DARBY & DARBY P.C., P. O. BOX 5257, NEW YORK, NY, 10150-5257, US

(73) Assignee: Mitsubishi Materials Corporation, Tokyo (JP)

(21) Appl. No.: 10/542,234

(22) PCT Filed: Mar. 28, 2003
(86) PCT No.: PCT/JP03/04020

§ 371 Date: Jul. 13, 2005

(30) Foreign Application Priority Data
Jan. 15, 2003 (JP) 2003-7062

(51) Int. Cl. B23D 57/00

(52) U.S. Cl. 83/835

(57) ABSTRACT

A cutting tool for machining a soft material is characterized by, on a substrate, a formation of an upward projecting protruding portion having a cutting blade ridge and a formation of an upward projecting pressing portion having a lower height than the protruding portion. The pressing portion adjoins at least the front side of the protruding portion in the rotational direction T (front side in the work material cutting direction). This cutting tool for machining a soft material may improve machining efficiency when conditioning the surface of a pad.

### TECHNICAL FIELD

The present invention relates to a tool for machining and conditioning the surface of a pad made of porous resin, rubber or polyurethane rubber and the like, such as a pad for polishing a semiconductor wafer and the like.

Priority is claimed on Japanese Patent Application No. 2003-007062, the content of which is incorporated herein by reference.

### BACKGROUND ART

With developments in the semiconductor industry in recent years, there is an increasing need for machining methods that finish metal, semiconductor and ceramic surfaces to a high degree of precision. In particular, the increasing integration of semiconductor wafers is requiring nanometer ( 1/1000 of a micron) order surface finishing. Because of this, CMP polishing (chemical mechanical polishing) using a porous pad (polishing cloth) has become common.

Clogging and compressive deformation occurs in a pad used for the polishing of semiconductor wafers and the like as the polishing time progresses, leading to a gradual change in its surface morphology. This causes undesirable phenomena such as a decrease in the polishing speed. In order to stabilize the surface condition of the pad and maintaining an excellent polishing state, the surface of the pad is periodically roughen by conditioning.

As an example of a pad conditioner used for conditioning a pad, there is one with a plurality of protruding portions projecting upward formed on the surface of a substrate, as disclosed in PCT International Publication No. 01/26862 (FIGS. 7 to 12). By pressing the surface of the substrate in this kind of pad conditioner against the surface of a pad being rotated about its axis at a fixed load, the substrate rotates with the rotational motion of the pad. The surface of the pad (work material) is then machined and conditioned by the protruding portions biting into the surface of the pad.

In the case of using a pad conditioner such as that shown in FIGS. 7 to 9 of patent document 1, as shown in FIG. 13A of the present application, because pad P serving as the work material is constituted of an elastically deformable material such as porous resin, rubber or polyurethane rubber, when protruding portion 2 formed on surface 1A of substrate 1 bites into pad surface P1, a concave deformation region P2 on the pad surface P1 contacting the protruding portion results that appears to evade the protruding portion 2.

Due to rotation of the substrate 1 (rotational direction T) there is relative movement of the protruding portion 2 toward the front side in the rotational direction T with respect to the pad surface P1. As a result, the concave deformation region P2, which appears to evade the protruding portion 2, always moves in the same direction as the direction of movement of the protruding portion 2 (shown by the outline arrow in the drawing). Thereby, the protruding portion 2 that forms a cutting edge does not work efficiently on the pad surface P1, and machining efficiency suffers.

Even by using such a pad conditioner as that shown in FIGS. 10 to 12 in the patent document 1, the same phenomenon as stated above results as shown in FIG. 13B of the present application.

### DISCLOSURE OF INVENTION

In view of the aforementioned problems, the object of the present invention is to provide a tool for conditioning the surface of a pad that may improve machining efficiency.

In order to attain the object, a cutting tool for machining a soft material of the present invention is characterized in that an upward projecting protruding portion having a cutting blade ridge is formed on the surface of a substrate constituted of a hard material and that an upward projecting pressing portion having a lower height than the protruding portion so as to adjoin at least the front side of the protruding portion in the work material cutting direction.

Such constitution, with respect to the pad surface that is the work material, not only makes the protruding portion bite into, but also makes the pressing portion push on, which adjoins at least the front side of the protruding portion in the work material cutting direction (for example, the front side in the rotational direction of the substantially circular disk-shaped substrate rotating about its axis). Thereby, this pressing portion, that is, at least the surface positioned on the front side in the direction of movement of the protruding portion, holds down a portion in the periphery of the concave deformation region that occurs from the bite of the protruding portion in at least the front side in the work material cutting direction.

Because of this, at least the pad surface just before being cut by the cutting blade ridge of the protruding portion is held down and restrained by the pushing portion. This suppresses movement of the concave deformation portion on the pad surface in the same direction as the protruding portion, thereby making the cutting blade ridge of the protruding portion operate efficiently on the pad surface.

In particular, when the pressing portion is formed so as to adjoin the entire periphery of the protruding portion, the periphery of the concave deformation region that occurs on the pad surface may be surely held down and restrained by the pressing portion.

In addition, although the ease of pad deformation depends on the type of pad to be conditioned, the height of the protruding portion with respect to the pressing portion is preferably set to a range of 0.005 to 0.5 mm, and the sectional area along the surface of the substrate at the upper end portion of the protruding portion is preferably set to a range of 0.0015 to 0.3 mm². With such a constitution the concave deformation region occurring from the bite of the protruding portion into the pad surface is formed in a suitable shape so that its periphery may be surely restrained by the pressing portion.

In addition, the sectional shape along the surface of the substrate at the upper end portion of the protruding portion preferably assumes a substantially circular surface shape or a substantially polygonal surface shape. The upper end of the protruding portion is preferably a flat surface that is substantially parallel with the surface of the substrate, a flat surface that is inclined with respect to the surface of the substrate, or a multi-level surface having a plurality of surfaces.

In addition, the hard material that constitutes the substrate is preferably ceramic having silicon carbide or silicon nitride or alumina as a main component or is a cemented carbide. Such a constitution may impart wear resistance and corrosion resistance to the cutting blade ridge and the like of the protruding portion formed on the surface of the substrate, enable to condition the pad stably over a long period of time without impairing sharpness, and may improve the strength of the protruding portion and the pressing portion.

In particular, when ceramic is selected as the material constituting the substrate, no risk arises of contamination due to dissolution of the substrate not only when conditioning a pad for CMP polishing using an alkaline or neutral slurry, but even for when conditioning the pad for CMP polishing of an LSI substrate containing tungsten wiring, copper wiring or the like using a strongly acidic slurry.

In addition, it is preferable that at least the cutting blade ridge portion in the protruding portion is coated with a chemical vapor deposition diamond. Such a constitution may improve the wear resistance imparted to the cutting blade ridge of the protruding portion.

In addition, the layer thickness of the chemical vapor deposition diamond coating layer is preferably set to a range of 0.1 to 100 μm. Such a constitution may impart sufficient wear resistance to the cutting blade ridge, the coating layer does not become brittle, and there is no cracking.

In addition, it is preferable that the entire face of the surface of the substrate is coated with a chemical vapor deposition diamond. Such a constitution may prevent contamination due to dissolution even if the substrate is constituted of a hard material with a risk of contamination due to dissolution (for example, a cemented carbide and the like) by coating the entire surface of the substrate, and moreover, improvement in the strength of the protruding portion and the pressing portion becomes possible.

### BRIEF DESCRIPTION OF THE DRAWINGS

FIG. 1A is a plan view of a cutting tool for machining a soft material according to a embodiment of the present invention, FIG. 1B is a main part enlarged perspective view in FIG. 1A, and FIG. 1C is a sectional view of the line X-X in FIG. 1A.

FIG. 2 is a main part enlarged sectional view of the appearance of conditioning the surface of a pad using the cutting tool for machining a soft material according to the embodiment of the present invention.

FIG. 3 is a main portion enlarged sectional view showing a modification of the cutting tool for machining a soft material according to the embodiment of the present invention.

FIG. 4 is a main portion enlarged perspective view showing a modification of the cutting tool for machining a soft material according to the embodiment of the present invention.

FIG. 5 is a main portion enlarged perspective view showing a modification of the cutting tool for machining a soft material according to the embodiment of the present invention.

FIG. 6 is a main portion enlarged perspective view showing a modification of the cutting tool for machining a soft material according to the embodiment of the present invention.

FIG. 7 is a main portion enlarged perspective view showing a modification of the cutting tool for machining a soft material according to the embodiment of the present invention.

FIG. 8 is a main portion enlarged perspective view showing a modification of the cutting tool for machining a soft material according to the embodiment of the present invention.

FIG. 9 is a main portion enlarged perspective view showing a modification of the cutting tool for machining a soft material according to the embodiment of the present invention.

FIG. 10 is a main portion enlarged perspective view showing a modification of the cutting tool for machining a soft material according to the embodiment of the present invention.

FIG. 11 is a plan view showing a modification of the cutting tool for machining a soft material according to the embodiment of the present invention.

FIG. 12 is a perspective view showing a modification of the cutting tool for machining a soft material according to the embodiment of the present invention.

FIG. 13A and FIG. 13B are main portion enlarged sectional views showing the appearance of conditioning the surface of a pad using examples of conventional pad conditioners.

### BEST MODE FOR CARRYING OUT THE INVENTION

Below, the embodiment of the present invention is explained while referring to the attached drawings.

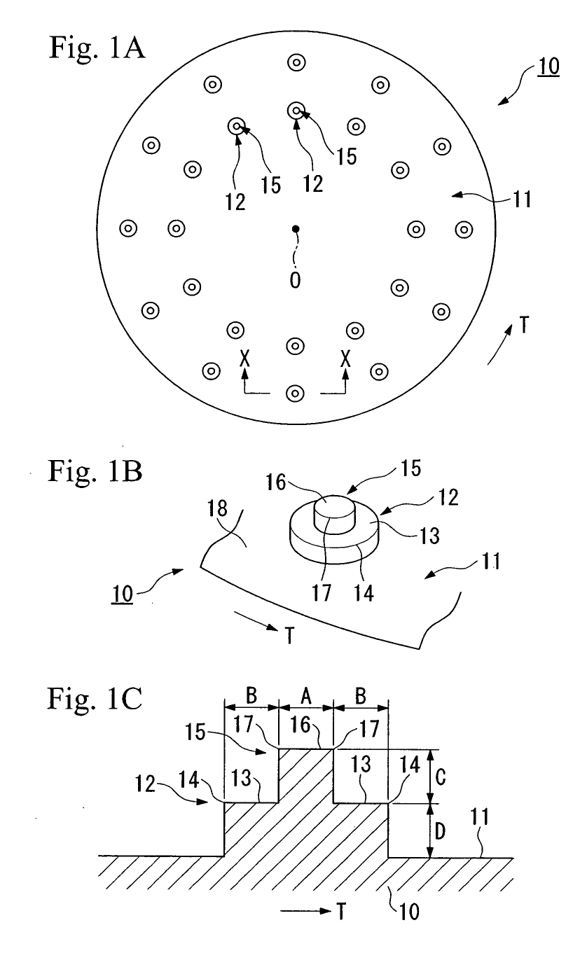

FIG. 1A is a plan view of the cutting tool for machining a soft material according to the embodiment of the present invention, FIG. 1B is a main part enlarged perspective view in FIG. 1A, and FIG. 1C is a sectional view of the line X-X in FIG. 1A.

A substrate (base material) 10 of the cutting tool for machining a soft material according to the embodiment of the present invention is centered on an axis O and constituted of a hard material so as to assume an substantially circular disk shape that is rotated (rotational direction T) about the axis O, and in the peripheral region of its surface 11 excluding the center region, for example, a plurality of upwardly projecting protruding portions 15 are formed so as to be arranged at substantially equal intervals in the circumferential direction.

In addition, pressing portions 12 having a lower height than the protruding portions 15 are formed projecting upward from the surface 11 of the substrate 10 similarly to the protruding portions 15 so as to adjoin (be continuous with) at least the front side of each of the plurality of protruding portions 15 in the rotational direction T (the side ahead of a straight line extending in the radial direction from the center of the substrate 10 forming an substantially circular disk shape). In the present embodiment, the pressing portions 12 are formed projecting upward so as to adjoin (be continuous with) the entire circumference of each of the plurality of projecting portions 15.

The plurality of protruding portions 15 each present an substantially circular cylindrical shape so that their sectional shape along the surface 11 of the substrate 10 (sectional shape substantially parallel with the surface 11 of the substrate 10) from the lower end portion connected to the surface 11 of the substrate 10 to the upper end portion assumes an substantially circular shape.

The plurality of pressing portions 12 each present an substantially circular cylindrical shape that is hollow (substantially circular cylindrical outer shape) so that their sectional shape along the surface 11 of the substrate 10 (sectional shape substantially parallel with the surface 11 of the substrate 10) from the lower end portion connected to the surface 11 of the substrate 10 to the upper end portion forms an substantially ring-shaped surface shape in which the protruding portion 15 with an substantially circular sectional surface shape is arranged in substantially the center.

In this way, the pressing portions 12 of a substantially circular cylindrical outer shape having a lower height than the protruding portion 15 are formed so as to adjoin the entire periphery of the substantially circular cylindrical protruding portions 15. Therefore, these protruding portions 15 and pressing portions 12 form two-level projections in which the substantially circular cylindrical element with a small outer diameter is placed on top of the circular cylindrical element with a large outer diameter so that it is as if, for example, their centers are aligned with each other.

In addition, an upper surface 16 that is the upper end of the substantially circular cylindrical protruding portion 15 is a substantially circular flat surface that is substantially parallel with the surface 11 of the substrate 10. A substantially circular intersecting ridge formed by the intersection of the upper surface 16 and circumferential surface (side surface) serves as a cutting blade 17 of this protruding portion 15. The upper surface that is the upper end of the pressing portion 12 having a substantially circular cylindrical outer shape is a pressing surface 13 that is a substantially ring-shaped flat surface substantially parallel with the surface 11 of the substrate 10.

Moreover, the pressing surface 13 that is the upper surface of the pressing portion 12 has a height D from the surface 11 of the substrate 10 that is set to 0.05 mm or more (for example, D=0.15 mm). The upper surface 16 of the protruding portion 15 has a height C from the pressing surface 13 of the pressing portion 12 (height with respect to the pressing portion 12) that is set to a range of 0.005 to 0.5 mm (for example, C=0.05 mm).

Here, as shown in FIG. 1C, length A along rotational direction T in the cross section along the surface 11 of the substrate 10 at the upper end portion of the protruding portion 15 (substantially the same as the outer diameter of the circumscribed circle of the cross section at the upper end portion of the protruding portion 15 along the surface 11 on the substrate 10), that is, the length in the rotational direction T on the upper surface 16 of the protruding portion 15 in the present embodiment, that, when viewed in the cross section along the rotational direction T of the substrate, passes through the center of the protruding portion 15 and the pressing portion 12 formed adjoining its periphery, is set to a range of 0.05 to 1.0 mm (for example, A=0.2 mm). In relation to specifying this length A, it is good for the sectional area along the surface 11 of the substrate 10 at the upper surface 16 of the protruding portion 15 (the surface area substantially parallel with the surface 11 of the substrate 10) to be set to a range of 0.0015 to 0.3 mm².

In addition, as similarly shown in FIG. 1C, because the pressing portion 12 is formed so as to adjoin at least the front side of the protruding portion 15 in the rotational direction T, the region on the front side in the rotational direction T in the substantially ring-shaped pressing surface 13 that is the upper surface of the pressing portion 12 is continuous with the front side in the rotational direction T of the protruding portion 15. A length B along the rotational direction T (length B along the rotational direction T on the pressing surface 13 of the pressing portion 12 positioned ahead of the protruding portion 15 in the rotational direction T) is set to 0.1 mm or more (for example, B=0.2 mm).

In particular, in the present embodiment, because the pressing portion 12 is formed so as to adjoin the entire periphery of the protruding portion 15, the pressing surface 13 of the pressing portion 12 is continuous with the entire periphery of the protruding portion 15. The width of this pressing surface 13 is set to the same range as B above over its entire circumference. The optimal values of the dimensions A, B, C and-D vary in accordance with the ease of deformation of pad P.

The substrate 10 with such a plurality of protruding portions 15 and plurality of pressing portions 12 disposed on the surface 11 is manufactured by, for example, performing grinding work and the like on a flat surface of an substantially circular disk-shaped substrate, so that the plurality of pressing portions 12 and the plurality of protruding portions 15 integrated with this surface 11 are formed on the surface 11 on the substrate 10.

The aforementioned substrate 10, including the protruding portions 15 and the pressing portions 12 integrally formed on its surface 11, is entirely constituted of a hard material such as ceramics having silicon carbide (SiC), silicon nitride (Si₃N₄) or alumina (A1₂O₃) as a main component.

The cutting tool for machining a soft material with the aforementioned constitution is used for actual machining after assembly by adhering a plate material made of SUS or resin and the like to the back face of the substrate 10 or shrink fitting the substrate 10 into concavities formed in the plate material made of SUS and the like.

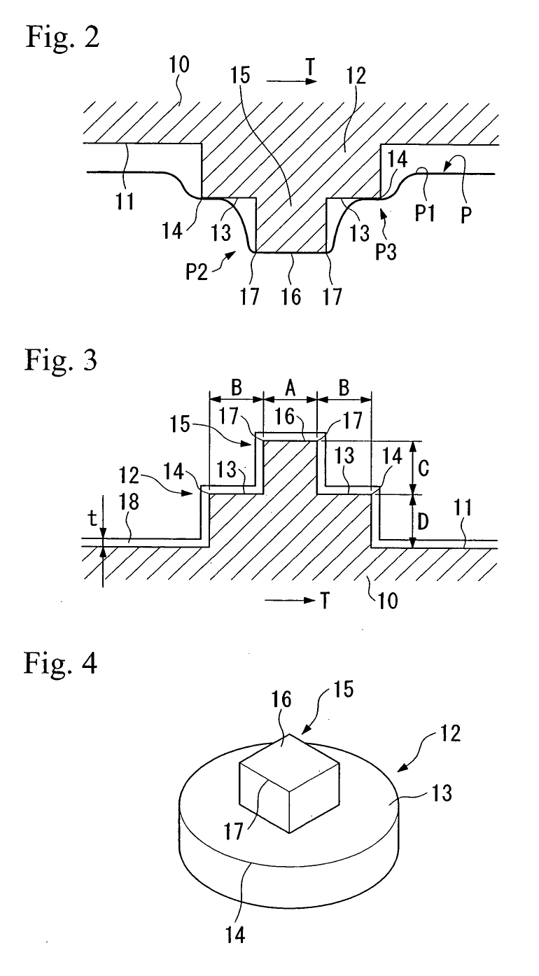

As shown in the main part enlarged sectional view of FIG. 2, the surface 11 of the substrate 10 of the cutting tool for machining a soft material in an assembled state is pressed by a fixed load against a surface P1 of the pad P made of porous resin, rubber or polyurethane rubber (having closed cells) that is rotated about its axis. Thereby, the substrate 10 undergoes rotational movement (in rotational direction T) about axis O accompanying the rotational movement of the pad P. The pad surface P1 is cut by the cutting blade ridges 17 formed on the plurality of protruding portions 15 biting into the pad surface P1, and cut chips generated by the cutting blade ridges 17 are ejected via gaps between protruding portions 15 or gaps and the like between pressing portions 12.

At this time, in the present embodiment the upwardly projecting pressing portion 12 with a lower height than the protruding portion 15 is formed so as to adjoin the entire periphery of the protruding portion 15 projecting upward from the surface 11 of the substrate 10. Therefore, a state arises in which not only does the protruding portion 15 bite into the surface P1 of the pad P, but also the pressing surface 13 of the pressing portion 12 is pressed against the surface P1 of the pad P. This produces a two-level concave deformation region on the surface P1 of the pad P in contact with the protruding portion 15 and the pressing portion 12 forming the two-level projection, the two-level concave deformation region appearing to evade the protruding portion 15 and the pressing portion 12.

In other words, on the pad surface P1, concave deformation region P3 is produced by the pressing of the substantially ring-shaped pressing surface 13 of the pressing portion 12 on the periphery of the concave deformation region P2 due to the bite of the upper surface 16 of the protruding portion 15. The entire periphery of the concave deformation region P2 due to the bite of the protruding portion 15 is restrained by being pressed by the substantially ring-shaped pressing surface 13 of the pressing portion 12.

Because of this, even if the protruding portion 15 undergoes relative movement to the front side in the rotational direction T (the front side in the work material cutting direction) with respect to the pad surface P1 due to rotation of the substrate 10 (in rotational direction T), the periphery of the concave deformation region P2 produced by the bite of the protruding portion 15 is held down and restrained by the substantially ring-shaped pressing surface 13 of the pressing portion 12. Therefore, movement in the same direction as the direction of movement of the protruding portion 15 is suppressed.

Doing so may make the cutting blade ridge 17 of the protruding portion 15 operate efficiently on the pad surface P1, dramatically improving the machining efficiency of the pad surface P1.

In particular, within the substantially ring-shaped pressing surface 13 of the pressing portion 12, the region of the front side in the rotational direction T (the front side in the work material cutting direction) holds down and restrains the portion on the front side in the rotational direction T in the periphery of the concave deformation region P2 (the portion on the front side in the work material cutting direction), that is, the pad surface P1 just before the cutting blade ridge 17 of the protruding portion 15 operates. Therefore, the cutting blade ridge 17 of the protruding portion 15 may be made to operate more efficiently on the pad surface P1.

Regarding the direction of movement of the protruding portion 15, although it may end up not only on the front side in the rotational direction T of the substrate 10 but also the back side and the like in the rotational direction T of the substrate 10 depending on the contact position between the surface 11 of the substrate 10 and the surface P1 of the pad P and their rotational speeds and the like, in the present embodiment the entire periphery of the concave deformation region P2 arising from the bite of the protruding portion 15 is held down and restrained by the pressing surface 13 of the pressing portion 12. Therefore, regardless of the direction in which the protruding portion 15 moves, the pad surface P1 just before the cutting blade ridge 17 of the protruding portion 15 operates may be restrained, thereby enabling the cutting blade ridge 17 to operate more efficiently with respect to the pad surface P1.

In addition, because the length A at the upper end portion of the protruding portion 15 along rotational direction T in the cross-section along the surface 11 of the substrate 10 is set to a range of 0.05 to 1.0 mm (preferably a range of 0.1 to 0.8 mm), the concave deformation region P2 in which the protruding portion 15 bite into the pad surface P1 is produced in a suitable shape, and its periphery may be surely restrained by the pressing surface 13 of the pressing portion 12.

Here, when the length A is smaller than 0.05 mm, there is the risk of the concave deformation region P2 arising from the bite of the protruding portion 15 being too small, leading to insufficient restraint of the periphery of the concave deformation region P2 arising from the pressing surface 13 of the pressing portion 12. On the other hand, if the length A is greater than 1.0 mm, there is the risk of the depth of the concave deformation region P2 arising from the bite of the protruding portion 15 becoming to shallow, leading to the loss of the ability to restrain the periphery of the concave deformation region P2 arising from the pressing surface 13 of the pressing portion 12.

Regarding the shape of the protruding portion 15 specified by this length A, when specifying by the sectional area along the surface 11 of the substrate 10 at the upper end portion of the protruding portion 15, this section area is preferably set to a range of 0.0015 to 0.3 mm² (and more preferably a range of 0.005 to 0.05 mm ²).

In addition, at the pressing surface 13 of the pressing portion 12, the length B along the rotational direction T of the region positioned ahead of the protruding portion 15 in the rotational direction T (the width of the pressing surface 13 adjoining and continuous with the entire periphery of the protruding portion 15) is set to 0.1 mm or more (preferably a range of 0.2 to 0.5 mm). This ensures a sufficiently large area of the pressing surface 13 of the pressing portion 12 so as to surely hold down and restrain the periphery of the concave deformation region P2 produced by the bite of the protruding portion 15 on the pad surface P1. When this length B is less than 0.1 mm, there is a risk that the area of the pressing surface 13 of the pressing portion 12 required for holding down and restraining the periphery of the concave deformation region P2 may no longer be sufficiently maintained.

In addition, the height C of the upper, surface 16 of the protruding portion 15 (from the surface 13 of the pressing portion 12) is set to a range of 0.005 to 0.5 mm (preferably a range of 0.01 to 0.5 mm, and more preferably a range of 0.01 to 0.1 mm). Thereby, the concave deformation region P2 arising from the bite of the protruding portion 15 on the pad surface P1 is produced in a suitable shape. Its periphery may therefore be surely restrained by the pressing surface 13 of the pressing portion 12 and conditioning of the pad surface P1 may be stably maintained.

Here, when this height C is less than 0.005 mm, the concave deformation region P2 arising from the bite of the protruding portion 15 becomes too small, leading to the risk of insufficient restraint of the periphery of the concave deformation region P2 by the pressing surface 13 of the pressing portion 12. On the other hand, if the height C is greater than 0.5 mm, the amount of bite of the pressing portion 15 on the pad surface P1 becomes too great, which may cause problems in the operation of the cutting tool for machining a soft material, and in extreme cases it may become inoperable.

In addition, the height D of the pressing surface 13 of the pressing portion 12 (from the surface 11 of the substrate 10) is set to 0.05 mm or more (preferably a range of 0.1 to 0.5 mm). Thereby,. conditioning of the pad surface P1 maybe stably maintained without the surface 11 of the substrate 10 making full contact with the pad surface 11. When this height D is less than 0.05 mm, the surface 11 of the substrate 10 comes into full contact the pad surface P1, causing an increase in frictional resistance and a dispersion of the load, which may have the opposite effect of causing a drop in machining efficiency.

Moreover, the substrate 10 in which protruding portions 15 and pressing portions 12 are integrally formed is constituted as a whole by a hard material comprising ceramics having silicon carbide or silicon nitride or alumina as a main component. This may impart wear resistance and corrosion resistance to the cutting blade ridge 17 and the like of the protruding portions 15 formed on the surface 11 of the substrate 10, enable a stable pad conditioning function to be maintained over a long period of time without impairing the sharpness, and make possible an improvement in the strength of the protruding portions 15 and the pressing portions 12.

In particular, when the substrate 10 is constituted of ceramics, the material comprising the substrate 10 does not dissolve and there is no fear of contamination not only when conditioning the surface P1 of the pad P for performing CMP polishing using an alkaline or neutral slurry, but even for when conditioning the surface P1 of the pad P for performing CMP polishing of an LSI substrate containing tungsten wiring or copper wiring or the like using a strongly acidic slurry.

In the present embodiment, as shown in FIG. 3, at least the cutting blade ridge 17 portion in the protruding portion 15 integrally formed with the surface 11 of the substrate 10, and particularly the entire surface 11 of the substrate 10 including the protruding portion 15 and the pressing portion 12, may be coated with a chemical vapor deposition diamond 18 at a layer thickness “t” in a range of 0.1 to 100 μm (preferably in a range of 0.5 to 20 μm, and more preferably in a range of 2 to 10 μm) (for example, “t” =10 μm).

Such a constitution enables improvement of the wear resistance and corrosion resistance of the cutting blade ridge 17 of the protruding portion 15 and the like and improvement of the strength of the protruding portion 15 and the pressing portion 12. In addition, even when a material such as cemented carbide which may pose a risk of contamination by dissolution is selected as the hard material constituting the substrate 10, no contamination occurs.

Here, when the layer thickness “t” of the chemical vapor deposition diamond 18 is less than 0.1 μm, there is a risk that the wear resistance imparted to the cutting blade ridge 17 may not be improved. On the other hand, when the layer thickness “t” is greater than 100 μm, the coating layer may conversely become brittle and crack easily.

The coating layer of the chemical vapor deposition diamond 18 is formed on the substrate 10 having a plurality of pressing portions 12 and protruding portions 15 by, for example, an existing method such as a method employing microwave plasma or a method employing a heat filament.

In addition, in the present embodiment, the protruding portion 15 assumes a substantially circular cylindrical shape so that the sectional shape at the upper end portion assumes a substantially circular shape, and the pressing portion 12 assumes a substantially circular cylindrical outer shape, but they are not limited thereto. The protruding portion 15 may assume a substantially polygonal cylindrical shape so that the sectional shape at the upper end portion assumes a substantially polygonal shape, and the pressing portion 12 may assume a substantially polygonal outer shape.

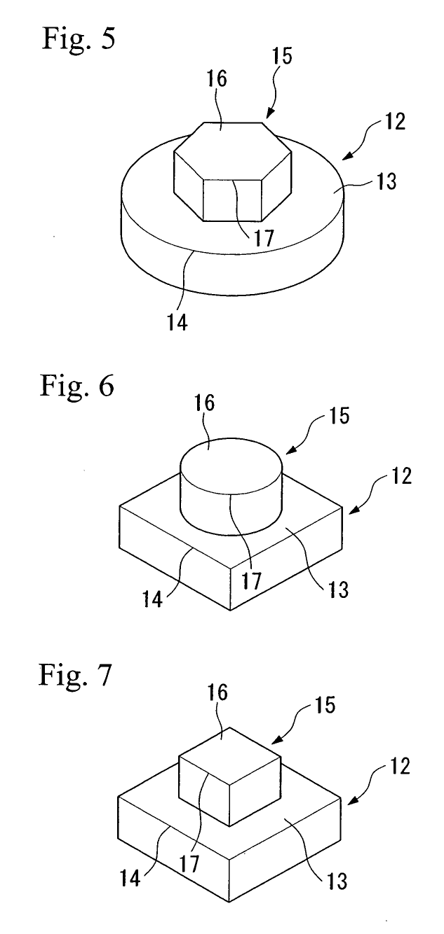

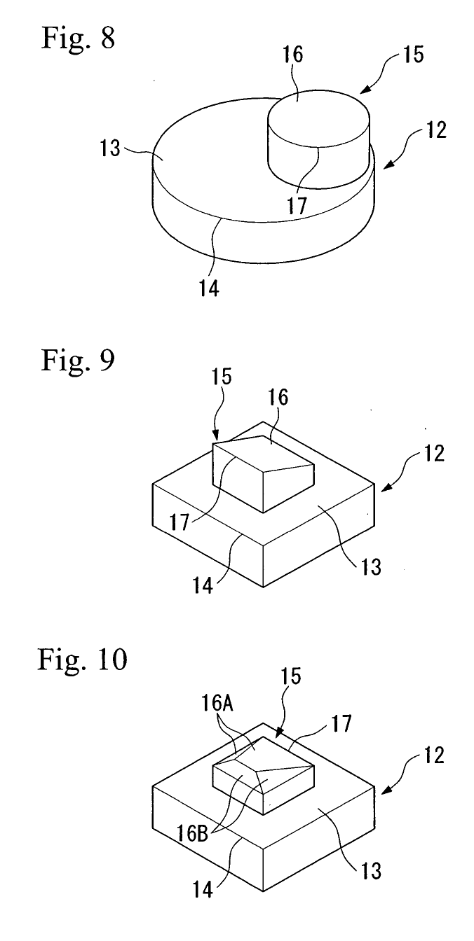

For example, as shown in FIG. 4, it may be a two-level projection having a protruding portion 15 assuming a substantially square cylindrical shape (with a substantially square sectional shape) and a pressing portion 12 assuming a substantially circular cylindrical outer shape. As shown in FIG. 5, it may be a two-level projection having a protruding portion 15 assuming a substantially hexagonal cylindrical shape (with a substantially hexagonal sectional shape) and a pressing portion 12 assuming a substantially circular cylindrical outer shape. As shown in FIG. 6, it may be a two-level projection having a protruding portion 15 assuming an substantially circular cylindrical shape and a pressing portion 12 assuming an substantially square cylindrical outer shape (with an substantially square sectional shape). As shown in FIG. 7, it may be a two-level projection having a protruding portion 15 assuming a substantially square cylindrical shape (with a substantially square sectional shape) and a pressing portion 12 assuming a substantially square cylindrical outer shape (with a substantially square sectional shape). In addition, as shown in FIG. 8, the protruding portion 15 and the pressing portion 12 may be in an eccentric state with their centers not aligned with each other.

In addition, in the present embodiment, the upper surface 16 that is the upper end of the protruding portion 15 is a flat surface that is substantially parallel with the surface 11 of the substrate 10, but it is not limited thereto. For example, as shown in FIG. 9, the upper surface 16 that is the upper end of the protruding portion 15 may be a flat surface that is inclined with respect to the surface 11 of the substrate 10 (tapered flat surface).

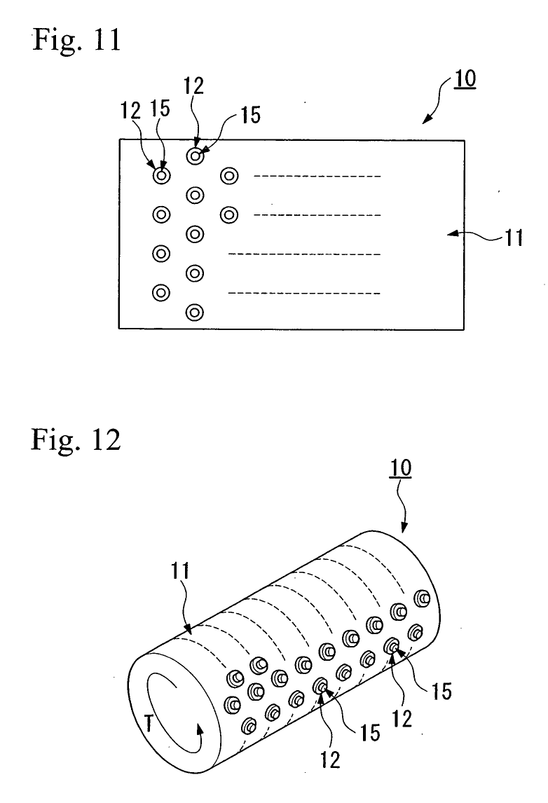

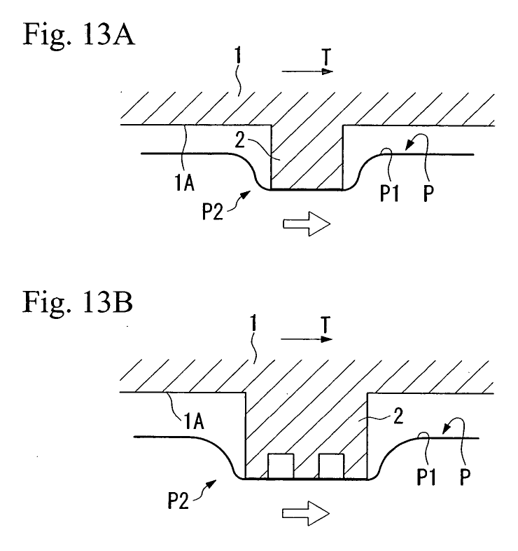

Moreover, the upper end of the protruding portion 15 may assume a multi-level surface having a plurality of surfaces. For example, as shown in FIG. 10, the upper end of the protruding portion 15 may be constituted of a plurality of surfaces 16A of different sizes, having intersecting ridge portions formed by the mutual intersection of these surfaces 16A, and may be formed in a convex shaped multi-level surface that is convex upward.

Here, in the modifications shown in FIGS. 8 to 10, the two-level projection having the protruding portion 15 and the pressing portion 12 are presented with a clear orientation (directionality), but when forming such two-level projections on the surface 11 of the substrate 10, it is preferable to arrange them so that variations occur in their orientation.

In addition, in the present embodiment two-level projections were made on the surface 11 of the substrate 10 forming a plurality of protruding portions 15 and pressing portions 12 adjoining the entire periphery of the protruding portions 15, but it is not limited thereto. For example, the plurality of adjoining pressing portions 12 may be integrated with each other.

Moreover, the substrate 10 (base material) in the present embodiment is made, centered on the axis O, so as to form a substantially circular disk shape that rotates about the axis O (rotational direction T), but it is not limited thereto.

For example, as shown in FIG. 11, a plurality of upward projecting protruding portions 15 and pressing portions 12 may be formed on the surface 11 of the substrate 10 assuming a substantially rectangular parallelepiped, the surface 11 being pressed against the surface P1 of the rotating pad P (adding oscillations as required to traverse the pad surface P1).

For example, as shown in FIG. 12, on the surface 11 that is the outer circumferential surface of the substrate 10 assuming an substantially circular cylindrical shape rotated about its axis, a plurality of upward projecting protruding portions 15 and pressing portions 12 (upward from the surface 11 of the substrate 10, that is, on the radial outer circumferential side of the substrate 10 assuming an substantially circular cylindrical shape) may be formed centered on the axis, and this surface 11 may be pressed against the surface P of a rotating pad P (adding oscillations as required to traverse the pad surface P1).

### TEST EXAMPLES

Below, the effectiveness of the present invention was verified by comparative tests with conventional examples, with an example of the present invention serving as a test example.

Test 1

Procured were a substrate 10 on whose surface 11 are formed a protruding portion 15 assuming a substantially circular cylindrical shape projecting upward and a pressing portion 12 assuming a substantially circular cylindrical outer shape, adjoining the entire circumference of the protruding portion 15 and projecting upward to a lower height than the protruding portion 15 by performing grinding work on the surface of the substantially circular disk-shaped substrate constituted of a hard material (test examples 1 to 9) and a substrate 1 with a protruding portion 2 assuming a substantially circular cylindrical shape formed on its surface 1A (conventional examples 1 and 2). Table 1 below shows the dimensions A to D of the protruding portion 15 and pressing portion 12 assuming a two-level projection in test examples 1 to 9, the dimensions A and C of the protruding portion 2 assuming a one-level projection in conventional examples 1 and 2 (height A from the surface 1A of the substrate 1 on the upper surface of the protruding portion 2, and length A along the rotational direction T in the cross section in the upper end portion of the protruding portion 2) and the hard materials constituting substrates 10 and 1 in the test examples 1 to 9 and the convention examples 1 and 2.

Table 1 shows the results of tests in which a cutting tool for machining a soft material having these substrates 10 and 1 (test examples 1 to 9, conventional examples 1 and 2) was mounted in a polishing machine (Musashino Electronics MA-300), and the surface of a-urethane foam pad for polishing a semiconductor wafer (Rodel IC 1400-Grv) was cut.

The pad removal rate in Table 1 is test as an index, with the amount cut from the pad surface P1 when using the cutting tool for machining a soft material according to test example 1 taken as 100 (the same applies to Tables 2 to 4 below).

TABLE 1

| | | | | | | Pad |
|---|---|---|---|---|---|---|
| | | A | B | C | D | removal |
| | Substrate material | (mm) | (mm) | (mm) | (mm) | rate |
| Test example 1 | SiC ceramics | 0.2 | 0.2 | 0.05 | 0.15 | 100 |
| Test example 2 | SiC ceramics | 0.2 | 0.2 | 0.02 | 0.15 | 70 |
| Test example 3 | SiC ceramics | 0.2 | 0.2 | 0.07 | 0.15 | 140 |
| Test example 4 | SiC ceramics | 0.2 | 0.2 | 0.10 | 0.15 | 90 |
| Test example 5 | Si₃N₄ ceramics | 0.1 | 0.2 | 0.07 | 0.15 | 150 |
| Test example 6 | Si₃N₄ ceramics | 0.15 | 0.2 | 0.07 | 0.15 | 160 |
| Test example 7 | Si₃N₄ ceramics | 0.4 | 0.4 | 0.07 | 0.15 | 80 |
| Test example 8 | Al₂O₃ ceramics | 0.4 | 0.4 | 0.07 | 0.15 | 80 |
| Test example 9 | Cemented carbide | 0.4 | 0.4 | 0.07 | 0.15 | 80 |
| Conventional | SiC ceramics | 0.2 | — | 0.2 | — | 5 |
| example 1 | | | | | | |
| Conventional | SiC ceramics | 0.2 | — | 0.05 | — | 8 |
| example 2 | | | | | | |

As shown in Table 1, in test examples 1 to 9 that are each an example of the present invention, the periphery of the concave deformation region P2 arising from the bite of the protruding portion 15 could be held down and restrained by the pressing surface 13 of the pressing portion 12, thereby enabling the cutting blade ridge 17 of the protruding portion 15 to operate efficiently on the pad surface P1.

In contrast, in the conventional example 1, the pad surface P1 could not be restrained, and so the cutting blade ridge of the protruding portion 2 did not operate efficiently on the pad surface P1, with the pad removal rate dropping markedly to 5. In the conventional example 2, because the height C of the upper surface of the protruding portion 2 was too low, the contact area between the surface 1A of the substrate 1 and the pad surface P1 increased, so that the load was no longer concentrated on the cutting blade ridge of the protruding portion 2. As a result, similarly to conventional example 1, the cutting blade ridge of the protruding portion 2 did not operate efficiently on the pad surface P1, with the pad removal rate dropping markedly to 8.

Test 2

Similarly to test 1, after procuring substrates 10 and 1 (test examples 10 to 14, conventional examples 3 and 4) constituted of ceramics having silicone carbide as a main component, these substrates 1 and 10 were set in a microwave CVD equipment and the surfaces 10A and 1A were entirely coated with a chemical vapor deposition diamond 18 (layer thickness “t”). Here, dimensions A to D and the coating thickness “t” of the chemical vapor deposition diamond 18 for test examples 10 to 14 and conventional examples 3 and 4 are as shown in Table 2 below.

Table 2 shows the results of tests in which a cutting tool for machining a soft material having these substrates 10 and 1 (test examples 10 to 14, conventional examples 3 and 4)was mounted in a polishing machine (Musashino Electronics MA-300), and the surface of a urethane foam pad for polishing a semiconductor wafer (Rodel IC 1000) was cut.

TABLE 2

| | | | | | | Pad |
|---|---|---|---|---|---|---|
| | t | A | B | C | D | removal |
| | (μm) | (mm) | (mm) | (mm) | (mm) | rate |
| Test example 10 | 0.2 | 0.2 | 0.2 | 0.05 | 0.2 | 130 |
| Test example 11 | 2.5 | 0.2 | 0.2 | 0.05 | 0.2 | 170 |
| Test example 12 | 10 | 0.2 | 0.2 | 0.05 | 0.2 | 100 |
| Test example 13 | 30 | 0.2 | 0.2 | 0.05 | | 100 |
| Test example 14 | 70 | 0.2 | 0.2 | 0.05 | | 80 |
| Comparative example 15 | 10 | 0.2 | — | 0.2 | — | 10 |
| Comparative example 16 | 10 | 0.2 | — | 0.05 | — | 20 |

As shown in Table 2, in test examples 1 to 9 that are each an example of the present invention, coating the entire surface 11 of the substrate 10 with the chemical vapor deposition diamond 18 produced a stable pad conditioning function without impairing sharpness and maintained the pad removal rate at a high level.

In contrast, in conventional example 3, although there was an improvement in the pad removal rate over conventional example 1 used in test 1, it remained low at 10. In addition, in conventional example 4, although there was an improvement in the pad removal rate over conventional example 2 used in test 1, it similarly remained low at 20.

Test 3

Procured was a substrate 10 (test examples 15 to 20) on whose surface 11 are formed a protruding portion 15 assuming an substantially polygonal cylindrical shape projecting upward and a pressing portion 12 adjoining the entire circumference of the protruding portion 15 and projecting upward to a lower height than the protruding portion 15 by performing grinding work on the surface of the substantially circular disk-shaped substrate constituted of ceramics having silicon carbide as a main component. In the substrate 10 of test examples 15 to 18, the upper surface 16 of the protruding portion 15 was flat and substantially parallel to the surface 11 of the substrate 10. In the substrate 10 of test example 19, the upper surface 16 of the protruding portion 15 was flat and inclined 10° with respect to the surface 11 of the substrate 10. In test example 20, the upper end of the protruding portion 15 was the multi-level surface shown in FIG. 3. Here, regarding test examples 15 to 20, the dimensions E, B, C and D and the shape of the protruding portion 15 are as shown in Table 3 below. Dimension E is the outer diameter of the circumscribed circle of the cross section at the upper end portion of the protruding portion 15 and is used in place of dimension A.

Table 3 shows the results of test in which a cutting tool for machining a soft material having these substrates 10 (test examples 15 to 20) was mounted in a polishing machine (Musashino Electronics MA-300), and the surface of a urethane foam pad for polishing a semiconductor wafer (Rodel IC1400-Grv) was cut.

TABLE 3

| | | | | | | Pad |
|---|---|---|---|---|---|---|
| | Protrusion | E | B | C | D | removal |
| | shape | (mm) | (mm) | (mm) | (mm) | rate |
| Test | Approximately | 0.2 | 0.2 | 0.05 | 0.2 | 95 |
| example 15 | circular cylindrical | | | | | |
| Test | Approximately | 0.2 | 0.2 | 0.05 | 0.2 | 230 |
| example 16 | square cylindrical | | | | | |
| Test | Approximately | 0.2 | 0.2 | 0.05 | 0.2 | 210 |
| example 17 | triangular cylindrical | | | | | |
| Test | Approximately | 0.2 | 0.2 | 0.05 | 0.2 | 160 |
| example 18 | hexagonal cylindrical | | | | | |
| Test | Approximately | 0.2 | 0.2 | 0.05 | 0.2 | 290 |
| example 19 | rectangular cylindrical | | | | | |
| Test | Approximately | 0.2 | 0.2 | 0.05 | 0.2 | 250 |
| example 20 | rectangular cylindrical | | | | | |

As shown in Table 3, while the test examples 15 to 20, which are examples of the present invention, have protruding portions 15 of various shapes, all attained a high pad removal rate.

Test 4

Procured was a substrate 10 having uniformly arranged on its surface 11 160 two-level projections, each having an upwardly projecting protruding portion 15 10 assuming an substantially circular cylindrical shape and a pressing portion 12 assuming an substantially circular cylindrical outer shape, adjoining the entire periphery of the protruding portion 15 and projecting upward to a lower height than the protruding portion 15, by performing grinding work on the surface of a substrate assuming an substantially rectangular parallelepiped shape (110×75 mm surface) constituted of a hard material having silicon carbide as a main component (test example 21).

Also procured was a substrate 10 having uniformly arranged on its surface 11 160 two-level projections, each having a protruding portion 15 assuming an substantially circular cylindrical shape projecting upward (radial outer circumferential side of the substrate 10 assuming an substantially circular cylindrical shape) and a pressing portion 12 assuming an substantially circular cylindrical outer shape, adjoining the entire periphery of the protruding portion 15 and projecting upward to a lower height than the protruding portion 15 by performing grinding work on the outer circumferential surface of the substrate assuming an substantially circular cylindrical outer shape (25 mm diameter x 100 mm) constituted of a hard material having silicon carbide as a main component (test example 22).

Next, only in test example 22 the entire surface 11 of the substrate 10 was coated with a chemical vapor deposition diamond 18 at a layer thickness t=2 μm. Table 4 below shows the dimensions A to D for test examples 21 and 22.

Table 4 shows the results of tests in which a cutting tool for machining a soft material having these substrates 10 (test examples 21 and 22) was mounted in a polishing machine (Musashino Electronics MA-300), and the surface of a urethane foam pad for polishing a semiconductor wafer (Rodel 1C1400-Grv) was cut.

In test example 21, the surface 11 of the substrate 10 assuming an substantially rectangular parallelepiped shape was pressed against pad surface P1, adding oscillations so as to traverse the pad surface P1 (10 reciprocations/min.). In test example 22, the surface 11 (outer circumferential surface) of the substrate 10 assuming an substantially circular cylindrical shape was pressed against pad surface P1 and rotated at a speed 10% slower than the pad P in the same direction as the rotational direction of the pad P, adding oscillations so as to traverse the pad surface P1 (10 reciprocations/min.).

TABLE 4

| | | | | | | Pad |
|---|---|---|---|---|---|---|
| | | A | B | C | D | removal |
| | Substrate shape | (mm) | (mm) | (mm) | (mm) | rate |
| Test | Approximately | 0.2 | 0.2 | 0.07 | 0.15 | 130 |
| example 21 | parallelepiped | | | | | |
| Test | Approximately | 0.2 | 0.2 | 0.07 | 0.15 | 160 |
| example 22 | circular cylindrical | | | | | |
| | outer diameter | | | | | |

As shown in Table 4, while the test examples 21 and 22, which are examples of the present invention, have substrates 10 of various shapes, all attained a high pad removal rate.

### INDUSTRIAL APPLICABILITY

The present invention relates to a tool for conditioning the surface of a pad made of porous resin, rubber or polyurethane rubber and the like, such as a pad for polishing a semiconductor wafer. The present invention may suppress movement of a concave deformation region on the pad surface in the same direction as the protruding portion, enable efficient operation of the cutting blade ridge of the protruding portion on the pad surface, and dramatically improve the machining efficiency of the pad surface.

1. A cutting tool for machining a soft material, characterized by a formation on a surface of a substrate constituted of a hard material of an upward projecting protruding portion having a cutting blade ridge and an upward projecting pressing portion having a lower height than the protruding portion so as to adjoin at least the front side of the protruding portion in a work material cutting direction.

2. A cutting tool for machining a soft material according to claim 1, wherein the pressing portion is formed so as to adjoin the entire periphery of the protruding portion.

3. A cutting tool for machining a soft material according to claim 1, wherein the height of the protruding portion with respect to the pressing portion is set to a range of 0.005 to 0.5 mm.

4. A cutting tool for machining a soft material according to claim 1, wherein a sectional area along the surface of the substrate at an upper end portion of the protruding portion is set to a range of 0.0015 to 0.3 mm².

5. A cutting tool for machining a soft material according to claim 1, wherein a sectional shape along the surface of the substrate at the upper end portion of the protruding portion assumes a substantially circular surface shape or a substantially polygonal surface shape.

6. A cutting tool for machining a soft material according to claim 1, wherein the upper end portion of the protruding portion is a flat surface that is substantially parallel with the surface of the substrate, a flat surface that is inclined with respect to the surface of the substrate, or a multi-level surface comprising a plurality of surfaces.

7. A cutting tool for machining a soft material according to claim 1, wherein the hard material is ceramics having silicon carbide or silicon nitride or alumina as a main component or is a cemented carbide.

8. A cutting tool for machining a soft material according to claim 1, wherein at least a cutting blade ridge portion in the protruding portion is coated with a chemical vapor deposition diamond.

9. A cutting tool for machining a soft material according to claim 8, wherein a layer thickness of the chemical vapor deposition diamond coating layer is set to a range of 0.1 to 100 μm.

10. A cutting tool for machining a soft material according to claim 8, wherein the entire face of the surface of the substrate is coated with a chemical vapor deposition diamond.

11. A cutting tool for machining a soft material, comprising:
a substrate having substantially a circular disk shape;
an upward projecting protruding portion formed on a peripheral region of the disk shaped substrate, the protruding portion having a cutting blade ridge and arranged in substantially equal intervals in the circumferential direction of the disk shaped substrate; and
an upward projecting pressing portion provided and adjoining the protruding portion at least at one side of the protruding portion, the pressing portion having a lower height than the protruding portion.

12. A cutting tool for machining a soft material according to claim 11, wherein the pressing portion is formed to adjoin the entire periphery of the protruding portion.

13. A cutting tool for machining a soft material according to claim 11, wherein the height of the protruding portion with respect to the pressing portion is set to a range of 0.005 to 0.5 mm.

14. A cutting tool for machining a soft material according to claim 11, wherein the upper end surface area of the protruding portion is set to a range of 0.0015 to 0.3 mm₂.

15. A cutting tool for machining a soft material according to claim 11, wherein the upper end surface area of the protruding portion assumes a substantially circular surface shape or a substantially polygonal surface shape.

16. A cutting tool for machining a soft material according to claim 11, wherein the upper end portion of the protruding portion is substantially parallel with the surface of the substrate, or is inclined with respect to the surface of the substrate, or has a plurality of surfaces.

17. A cutting tool for machining a soft material according to claim 11, wherein the substrate is made of ceramics containing silicon carbide or silicon nitride or alumina as a main component or is made of a cemented carbide.

18. A cutting tool for machining a soft material according to claim 11, wherein at least a cutting blade ridge portion in the protruding portion is coated with a chemical vapor deposition diamond.

19. A cutting tool for machining a soft material according to claim 18, wherein a layer thickness of the chemical vapor deposition diamond coating layer is set to a range of 0.1 to 100 μm.

20. A cutting tool for machining a soft material according to claim 18, wherein the entire face of the surface of the substrate is coated with a chemical vapor deposition diamond.
